(19) United States
(12) Patent Application Publication
(10) Pub. No.: US 2007/0113471 A1
(43) Pub. Date: May 24, 2007

(54) Agricultural soil heating processes using aromatic thermoplastic polyurethane films

(76) Inventors: Uri Peled, Zichron Yaakov (IL); Steven P. Crain, Midland, MI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/573,264

(22) PCT Filed: Sep. 10, 2004
(86) PCT No.: PCT/US04/29386

§ 371 Date: Mar. 23, 2006

(30) Foreign Application Priority Data
Sep. 12, 2003 (US) 60/502,536

(51) Int. Cl. A01G 1/00

(52) U.S. Cl. 47/58.1 SC

(57) ABSTRACT

Agricultural soil heating processes, including mulching, green house covering and especially solar soil sterilization are improved using a plastic film or sheet of an aromatic thermoplastic polyurethane.

### BACKGROUND OF THE INVENTION

Plastic films are used in several agricultural processes for their cost effective ability to transmit light needed for plant growth, block light (when pigmented) to prevent weed growth and/or retain heat and moisture in the soil. These uses include mulching, green house covering and solar soil sterilization.

In mulching, the film is placed on the ground and the desired plants grow through holes or between the sheets. The films can be used to retain the soil heat and moisture for plant root systems as well as control of weed growth. See for example EP 398,243 and EP 1,028,619.

Covering films for green houses can be used in the larger scale green house buildings as well as in smaller scale structures known as walking tunnels where the film is spread over ribs and creates a tunnel that allows several rows of growing crops and agricultural personnel access and passage. Green house covering films provide for light transmission and retain heated air around the growing plants to allow farming in seasons or climates that would otherwise be too cold for effective agricultural crop production.

Solar soil sterilization (also referred to as solarization) is a hydrothermal process used to suppress or eliminate soil-borne pests and pathogens. In a typical solarization process the soil is moistened, and covered with plastic tarps, typically clear polyethylene films. Then, by exposure to direct sunlight in tropical climates or during warm summer months in more temperate regions, the solar radiation heats the soil and raises temperatures sufficiently to suppress or eliminate soil-borne pests and pathogens. In areas with a suitable climate, solarization can be used alone, or in combination with lethal or sublethal fumigation or biological control, to provide an effective substitute to chemical treatments or fumigants such as methyl bromide. In addition to disinfesting the soil while reducing or eliminating the need for fumigants, solarization leaves no toxic residues and can contribute to water conservation. Furthermore, solarization increases the levels of available mineral nutrients in soils by breaking down soluble organic matter and increasing bioavailability. Moreover, there are beneficial organisms in the soils, such as viruses and fungi, that would be destroyed by chemical fumigants but are not as adversely affected by solarization.

Although solarization can be viable in the upper layers of the soil and in many warm climates, the level of heat and duration are often not adequate to penetrate into and sterilize deeper soil levels. There is therefore a need for improved soil solarization techniques that will provide higher soil temperatures for longer times at a consistently deep soil level and provide more effective crop growing conditions for agriculture.

According to this invention, it has been found that these agricultural processes are improved by the use of certain TPU agricultural films.

### SUMMARY OF THE INVENTION

The present invention addresses the deficiencies in the art by providing improved agricultural soil heating processes using an aromatic thermoplastic polyurethane film or sheet, preferably having a thickness of from about 20 to about 150 microns. In another embodiment the aromatic thermoplastic polyurethane comprises a polyether or polyester type of soft segment. Preferably, the improved agricultural soil heating process is solar soil sterilization.

### DETAILED DESCRIPTION OF THE INVENTION

The key feature in the improved processes according to the present invention is the use of films of aromatic thermoplastic polyurethane resins (aromatic TPU's). Aliphatic TPUs, available under such tradenames as Texin DP7-3006 and 3008, are based on aliphatic isocyanates such as hydrogenated or saturated MDI and are known to have improved color and clarity retention in outdoor, sunlight exposure applications. They have, however, been found to be inferior for use in the processes according to the present invention based on their lower tensile strength, reduced heat retention, inherent tackiness during processing/handling and high cost.

The aromatic TPU's suited for use in the films according to the invention are linear, segmented block copolymers based on one or more aromatic isocyanate. These materials are commercially available including under the tradename Pellethane from The Dow Chemical Company. The preferred TPU's comprise aromatic structural units which are remnants of the aromatic diisocyanate reactants and are represented by the following formula: 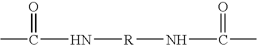
where R is an arylene group. Preferred aromatic diisocyanates include 4,4′-diisocyanato-diphenylmethane, p-phenylene diisocyanate, 1,5-naphthalene diisocyanate, 3,3′-dimethyl-4,4′-biphenyl diisocyanate, and 2,4-toluene diisocyanate. Most preferred is 4,4′-diisocyanato-diphenylmethane.

The combination of the aromatic isocyanate with short chain diols (including mixtures thereof) is referred to as the “hard” segment and provides elastomeric properties in the polymer and film. In general, it is preferred to use TPU's having a hard segment content of at least 30%, preferably greater than 40% by weight. Suitable short chain diols (also referred to as “chain extenders”) include 1,4-butane diol; 1,6-hexanediol; cyclohexyldimethanol; ethylene glycol; diethylene glycol, 1,2-propanediol with the most preferred being 1,4-butane diol.

A structural unit of 1,4-butane diol as incorporated in the polymer from the reaction of 1,4-butane diol is represented by the following formula:
—OCH₂CH₂CH₂CH₂O—

A structural unit of ethylene glycol is represented by the following formula:
—OCH₂CH₂O—

A structural unit of diethylene glycol is represented by the following formula:
—O—(CH₂CH₂O)₂—

The soft segment is a reaction product of the isocyanate and a low molecular weight polyol of 500 to 3,000 molecular weight that provides excellent low temperature mechanical properties in the polymer. Soft segments can be a polyether, polycarbonate or polyester type or based on mixture of two or more of these. Polyethers can include propylene oxide/ethylene oxide copolymers, polyethylene oxide, polytetramethylene glycol (PTMEG) or combinations of these.

A structural unit of ethylene oxide polyol is represented by the following formula:
—O—(CH₂CH₂O)ₓ—
where x is from 10 to 100. Ethylene oxide incorporation into propylene oxide based polyols is well known in the industry. Such incorporation may occur either through a block co-polymer structure, a tapered concentration block, or by random incorporation into the entire polymer chain. Tapered and block incorporation of EO onto PO chains are preferred. Most preferred is incorporation of EO into well defined structural blocks. Incorporation of EO on to PO polymers from 7 percent to 50 percent by weight is preferred. More preferred is 30 percent to 45 percent incorporation of EO.

A structural unit of a PTMEG polyol is represented by the following formula:
—O(CH₂CH₂CH₂CH₂O)ₓ—
where x can be from 7 to 47.

Some of the more common types of suitable polyesters include polycaprolactone and polyadipate. The selection of polycaprolactone or polyadipate for use in preparation of the TPU significantly affects the TPU properties. As known by practitioners in this area, these polyesters can range in molecular weight and can be initiated by various chain extenders (including those used to make the final TPU product) including 1,4-butane diol; 1,6-hexanediol; cyclohexyldimethanol; ethylene glycol; diethylene glycol, triethylene glycol, and 1,2-propanediol with the most preferred being 1,4-butane diol.

The choice of polyol in the soft segment affects the relative suitability for a given application. For use in wet environments, for example, a polyether-based TPU is preferred. When oil and hydrocarbon resistance are primary factors, a polyester-based TPU is the material of choice. A wide variety of property combinations can be achieved by varying the molecular weight of the hard and soft segments, their ratio and chemical type. For example, shore hardness ranges from 60A to 80D can be achieved. TPU films also offers high tensile strength, elongation and tear resistance and clarity relative to films of polyethylene, polyethylene/ethylene vinyl acetate blends; and PC or its blends.

The starting materials are used in amounts effective to produce a TPU suitable for preparing the known types of films including extruded, cast, blown or calendar. The optimum thickness for the films depends to some degree upon the type of soil heating process in which they will be used and the physical properties that are needed. The films used in these processes should generally be at least 5 microns in thickness, preferably at least 10, more preferably at least 15 microns, more preferably at least 20 microns and, primarily for cost effectiveness, should not be more than 220 microns in thickness and preferably less than 150 microns in thickness. For large area and green house cover films, the thickness can be up to 80 microns. Preferable films for mulching, walking tunnels and low tunnels are less than 70 microns, more preferably less than 60 and more preferably less than 50 microns in thickness. For mulching the films are more preferably less than about 40 microns in thickness. It is generally desired to reduce film thickness as much as permitted to reduce costs but maintain the thickness needed for the physical properties for these applications and provide the needed balance of light transmission and IR radiation absorption that these aromatic TPU's provide.

The suitable TPUs are also characterized by having a Shore D hardness of not more than 75 and/or a Tg of less than 25° C., preferably a Shore D hardness of not more than 65. The suitable TPUs are also characterized by having a Shore A hardness of at least 80, preferably a Shore A hardness of at least 85, and most preferably a Shore A hardness of at least 90. The preferred TPU's are further characterized by having a total optical transmission rate of at least 70 percent, preferably at least 80 percent, more preferably at least 85 percent. Preferable TPU's have a tensile strength of at least 2500 psi, and most preferable TPU's combine this tensile strength with the desired optical transmission values mentioned.

It has been found that the processes according to the invention are most effective when the TPU films contain anti-fog additives that reduce the surface tension of the film and cause the condensation to either drain off the film surface or form a uniform thin water layer that doesn't scatter or reflect the sun light. Antifogging additives, such as Atmer 400™, are generally non-ionic surfactants. The main chemical classes are: glycerol esters, polyglycerol esters, sorbitan esters, ethoxylated sorbitan esters and primary amides-erucamide, oleamide and stearamide types of products.

It has been found that the processes according to the invention are most effective when the TPU films contain additives that improve the resistance of the TPU to yellowing or other degradation effects that would otherwise be caused or accelerated by the long term exposure to UV radiation. The known UV stabilization additives that can be used for this purpose include hindered amine light stabilizer. UV absorbers such as benzophenones or benzotriazoles can also be used to protect the film and the crops from damaging UV radiation. For the preferred films for use according to the present invention, it is important to sufficiently incorporate and thoroughly disperse the additives, especially the UV stabilization additives, into the TPU resin. Preferably the resin contains the dispersed additives prior to being supplied to a film extrusion step, which does not typically have sufficient mixing when additives are incorporated in a salt and pepper fashion, the most common technique for incorporating additives into film resins. More preferably the additives are compounded into the resin during a reactive extrusion step in the resin production process. This avoids having sections of the resins containing higher additive concentration surge through the extruder and/or having areas of film with lower additive concentrations degrade unacceptably when the film is put into use.

The general techniques for use of agricultural films are well known as described above. The improved processes according to the present invention involve primarily the use of aromatic TPU films to replace the known films which are used in these applications. It is theorized that the aromatic TPU films provide improved retention of the heat due to absorption or reflectance of IR radiation and retention of that heat in the soil. Otherwise, after the soil is heated, IR radiation of the heat energy outward is a mechanism by which the heated soil loses significant amounts of the heat that has been generated. Polyethylene film, the large percentage of the film used in these applications, simply allows the transmission of this radiation out to the atmosphere. Aromatic TPU's also provide better and much more cost effective retention of IR radiant heat and generally soil heating process than aliphatic thermoplastic polyurethanes.

A good example of the improved processes and accompanying benefits that are provided can be seen in the area of solar soil sterilization (soil solarization). In this process, prior to application of the plastic film, the soil is prepared to provide a smooth, even surface for the areas to be covered by the film and allow water to penetrate evenly and deeply into the soils in those areas. Application of proper soil moisture and achieving a moisture equilibrium to the desired soil treatment depth is important to heat transfer in the soil. The fields are either irrigated prior to applying the plastic tarp or irrigation lines can be installed beneath the tarp and utilized as necessary. The areas to be treated are covered with continuous plastic films either manually or mechanically using plastic-laying machinery. Where necessary, sheets of plastic are connected or overlapped and held down at the edges with narrow bands of soil. Using the process according to the invention, the connection of sheets is facilitated due to the weldability of the aromatic TPU by means of heat, pressure, or radio frequency versus polyethylene films which require a glue.

The layer of film is applied to the soil prior to planting and is left in place for as long as needed to provide the sterilization needed in a given area depending upon the weather conditions. In order to cause any physical, chemical, and biological changes in the soil, the soil temperatures must be raised to temperatures above 38° C. for a sufficient period of time. The higher the temperature and the longer time period that the temperature can be maintained will accelerate the sterilization. When this is done, pathogens and pests are either killed directly by the heat or are weakened by sublethal heat to the extent that they are unable to damage crops.

For example, with the process according to the present invention, solarization time in the hot season in Mediterranean climates will typically be on the order of 3 weeks compared to solarization times on the order of 6 weeks with polyethylene films. The effectiveness of solarization and the heat dosages achieved during solarization depend on soil moisture and texture; air temperature (maxima, minima, and duration); season; length of day; intensity of sunlight; wind speed and duration; and the type, color, and thickness of the plastic. Using the process according to the invention, the time required for solarization can be reduced and/or more effective sterilization is provided in a given amount of time due to the better heating and heat retention effect of the aromatic TPU films. The process according to the present invention thus provides improved crop production in a crop growing cycle and can provide more crop growth cycles for a given area of land.

Using double layers of plastic with or without at least some air space between will result in even greater temperature increases in soils than achieved under a single layer of plastic. For example, preferred two-layer systems include “low tunnel” systems where one layer of film lies on the ground and the second is raised 30 to 50 centimeters in a tent or tunnel structure. The two layers can also be partially separated (with some airspace between) by rod or irrigation hose and contacting each other in some areas and still have considerable benefit over a single layer. Regardless of the technique used, the beneficial effects of solarization may persist for up to 2 growing cycles or more after the plastic is removed.

The known techniques for mulching and green house covering will also benefit from improved soil heating using aromatic TPU films. In mulch and green house covering the improved thermal characteristics of the TPU film also create more ideal (higher temperature) growing environments for plants, allowing planting earlier or out of season for many varieties of plants and vegetables. This results in healthier plants, earlier, more abundant and higher quality yields with TPU mulch and green house films. The use of TPU films in green houses also results in lower costs associated with heating green houses during cooler growing periods.

The following examples are for illustrative purposes only and are not intended to limit the scope of this invention. All percentages are in weight percent unless otherwise noted.

### EXAMPLES

In tests of films for use in the agricultural processes according to this invention, the soil heating properties of films were tested under summer conditions in Israel. Illustrating the processes according to the invention, a 50 micron film was prepared from an aromatic polyether-type TPU containing a standard combination of the following types of additives: antifog, HALS, UV absorber, anti block. The aromatic TPU film was compared to a 40 micron, LDPE film with similar additives.

Both films were used in a low soil solarization tunnel, with one layer on the ground and the second formed into the tunnel roof with a height of about 40 centimeters (cm) at the peak and the edges held down by soil. Temperature measurement probes were placed in the ground under the center of the tunnels at depths of 10, 20 and 40 cm and temperatures read electronically in degrees Celsius every hour. As shown by the daily maximum (max) and minimum (min) temperatures recorded in Table 1 below, the soils under the aromatic TPU film showed much better heating with consistently higher temperatures than under the polyurethane films.

TABLE 1
Soil Temperatures Measured at Various Soil Depths

| | | Soil Depth | | | | | |
|---|---|---|---|---|---|---|---|
| | | 10 cm | | 20 cm | | 40 cm | |
| | | PE | TPU | | TPU | | TPU |
| Day | | Film | Film | PE Film | Film | PE Film | Film |
| 1 | min | 27.8 | 32.0 | 25.9 | 27.0 | 27.2 | 27.8 |
| | max | 49.1 | 54.6 | 42.0 | 43.6 | 34.4 | 35.2 |
| 2 | min | 29.8 | 33.7 | 31.6 | 34.2 | 32.1 | 33.3 |
| | max | 50.8 | 56.9 | 44.7 | 47.3 | 37.0 | 38.5 |
| 3 | min | 31.5 | 35.7 | 33.3 | 36.2 | 33.8 | 35.5 |
| | max | 53.0 | 60.0 | 46.9 | 50.1 | 38.7 | 40.8 |
| 4 | min | 33.0 | 38.0 | 35.0 | 38.3 | 35.4 | 37.4 |
| | max | 53.5 | 60.6 | 47.6 | 50.8 | 39.9 | 42.0 |
| 5 | min | 33.2 | 38.4 | 35.1 | 39.1 | 36.3 | 38.4 |
| | max | 54.2 | 61.6 | 47.8 | 51.1 | 40.6 | 42.7 |
| 6 | min | 33.6 | 38.7 | 35.8 | 39.6 | 36.7 | 38.9 |
| | max | 53.9 | 62.3 | 48.0 | 50.9 | 40.9 | 43.0 |
| 7 | min | 33.9 | 38.8 | 36.4 | 39.9 | 37.2 | 39.3 |
| | max | 53.5 | 62.8 | 48.0 | 50.4 | 40.8 | 42.9 |

This improvement in heat retention is useful for both green house covering and mulching but is particularly surprising and useful in the soil solarization process where treatment time can be greatly reduced compared to the use of polyethylene films.

1. An improved agricultural soil heating process using a plastic film characterized in that the plastic film or sheet is an aromatic thermoplastic polyurethane film or sheet.

2. The improved process according to claim 1 where the thickness of the thermoplastic polyurethane film or sheet is from about 20 to about 150 microns.

3. The improved process according to claim 1 where the thermoplastic polyurethane used to prepare the film or sheet is an aromatic thermoplastic polyurethane comprising a polyether type of soft segment.

4. The improved process according to claim 1 where the thermoplastic polyurethane used to prepare the film or sheet is an aromatic thermoplastic polyurethane comprising a polyester type of soft segment.

5. The improved process according to claim 1 where the agricultural soil heating process is solar soil sterilization.

6. The improved process according to claim 1 where the thermoplastic polyurethane used to prepare the film or sheet is an aromatic thermoplastic polyurethane comprising a hard segment content of at least 30 percent by weight.

7. The improved process according to claim 1 where the thermoplastic polyurethane used to prepare the film or sheet is an aromatic thermoplastic polyurethane comprising a hard segment content of at least 40 percent by weight.

8. The improved process according to claim 1 where the thermoplastic polyurethane used to prepare the film or sheet is an aromatic thermoplastic polyurethane having a Shore A hardness of at least 80

9. The improved process according to claim 1 where the thermoplastic polyurethane used to prepare the film or sheet is an aromatic thermoplastic polyurethane having a Shore A hardness of at least 85.

10. The improved process according to claim 1 where the thermoplastic polyurethane used to prepare the film or sheet is an aromatic thermoplastic polyurethane having a Shore A hardness of at least 90.

11. The improved process according to claim 1 where the thermoplastic polyurethane used to prepare the film or sheet is an aromatic thermoplastic polyurethane having a Shore D hardness of not more than 75.

12. The improved process according to claim 1 where the thermoplastic polyurethane used to prepare the film or sheet is an aromatic thermoplastic polyurethane having a Tg of less than 25° C.

13. The improved process according to claim 1 where the thermoplastic polyurethane used to prepare the film or sheet contains the dispersed additives prior to being supplied to a film extrusion step.
